(19) United States
(12) Patent Application Publication
(10) Pub. No.: US 2005/0250929 A1
(43) Pub. Date: Nov. 10, 2005

(54) Ferrocenium-derived catalyst for cationically polymerizable monomers

(75) Inventor: Sarah M. Mullins, St. Paul, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/842,360

(22) Filed: May 10, 2004

(51) Int. Cl. C08G 59/68

(52) U.S. Cl. 528/92

(57) ABSTRACT

Polymerization methods are provided for thermally curing a polymerizable composition that contains at least one cationically polymerizable monomer. More specifically, the polymerization reaction is initiated with a ferrocenium-derived catalyst. Polymerizable compositions that include the ferrocenium-derived catalyst are also disclosed.

### BACKGROUND

Transition metal salts that include an organometallic cation and a non-nucleophilic anion have been used as initiators for polymerization reactions. More specifically, transition metal salts have been used as photochemically activated initiators as well as thermally activated initiators for polymerization reactions involving cationically polymerizable monomers.

Some of the transition metal salts that have been used as initiators in photochemically activated polymerization reactions include an organometallic cation having cyclopentadienyl and arene ligands attached to an iron ion. However, in some applications, the polymerization reactions occur in a closed environment such as within a mold or in a laminated article. The use of photochemically activated polymerization reactions can be impractical or undesirable in these closed environments. In other polymerization reactions, opaque materials such as fillers or pigments are included in the polymerizable compositions. These opaque materials tend to absorb at least some of the actinic radiation needed to photochemically activate an initiator.

Some of the transition metal salts that have been used as initiators in thermally activated polymerization reactions tend to be difficult to synthesize. Further, to provide rapid cure, accelerators are often added along with the transition metal salt to initiate the polymerization reaction. In other applications, because of the oxygen sensitivity of the transition metal salts that have been used, stabilizing agents are needed to obtain a suitable pot life for the composition.

### SUMMARY

Polymerization methods are provided for thermally curing a polymerizable composition that contains at least one cationically polymerizable monomer. More specifically, the polymerization reaction is initiated with a ferrocenium-derived catalyst. Polymerizable compositions that include the ferrocenium-derived catalyst are also disclosed.

In one aspect, a method of forming a polymer is provided. In this method, a ferrocenium-derived catalyst is formed prior to combination with cationically polymerizable monomers. A mixture is formed that includes an alcohol and a ferrocenium salt of Formula I.
(Cp)₂FeX I
In Formula I, Cp is a cyclopentadienyl group that is unsubstituted or substituted with up to three substituents; and X is an anion that is a tris-(fluorinated alkylsulfonyl)methide, bis-(fluorinated alkylsulfonyl)imide, tris-(fluorinated arylsulfonyl)methide, tetrakis-(fluorinated aryl)borate, alkyl sulfonate, fluorinated alkyl sulfonate, aryl sulfonate, fluorinated aryl sulfonate, or halogen-containing complex of a metal or metalloid. The mixture of the alcohol and the ferrocenium salt is treated with a gas that includes oxygen to form a catalyst composition. The catalyst composition is combined with at least one cationically polymerizable monomer to form a polymerizable composition. The polymerizable composition is thermally cured to form a polymeric material.

In a second aspect, another method of preparing a polymer is provided. In this method, a ferrocenium-derived catalyst is formed while in the presence of cationically polymerizable monomers. A polymerizable composition is formed that includes a monomer having at least one cationically polymerizable group, methanol, and a ferrocenium salt of Formula I.
(Cp)₂FeX I
In Formula I, Cp is a cyclopentadienyl group that is unsubstituted or substituted with up to three substituents; and X is an anion that is a tris-(fluorinated alkylsulfonyl)methide, bis-(fluorinated alkylsulfonyl)imide, tris-(fluorinated arylsulfonyl)methide, tetrakis-(fluorinated aryl)borate, alkyl sulfonate, fluorinated alkyl sulfonate, aryl sulfonate, fluorinated aryl sulfonate, or halogen-containing complex of a metal or metalloid. The polymerizable composition has a molar ratio of cationically polymerizable groups to methanol that is at least 12:1. The polymerizable composition is thermally cured using a process that includes exposing the polymerization composition to a gas that contains oxygen.

In a third aspect, a polymerizable composition is provided that includes a monomer having at least one cationically polymerizable group, methanol, and a ferrocenium salt of Formula I.
(Cp)₂FeX I
The polymerizable composition has a molar ratio of cationically polymerizable groups to methanol that is at least 12:1. In Formula I, Cp is a cyclopentadienyl group that is unsubstituted or substituted with up to three substituents; and X is an anion that is a tris-(fluorinated alkylsulfonyl)methide, bis-(fluorinated alkylsulfonyl)imide, tris-(fluorinated arylsulfonyl)methide, tetrakis-(fluorinated aryl)borate, alkyl sulfonate, fluorinated alkyl sulfonate, aryl sulfonate, fluorinated aryl sulfonate, or halogen-containing complex of a metal or metalloid.

As used herein, the terms “a”, “an”, and “the” are used interchangeably with “at least one” to mean one or more of the elements being described.

The above summary is not intended to describe each disclosed embodiment or every implementation of the present invention. The detailed description section that follows more particularly exemplifies these embodiments.

### DETAILED DESCRIPTION

Ferrocenium-derived catalyst can be used to initiate thermally activated polymerization reactions of cationically polymerizable monomers. The ferrocenium-derived catalyst can be formed before addition to cationically polymerizable monomers or can be formed in the presence of cationically polymerizable monomers.

In one aspect, a method of preparing a polymer is provided that includes forming a mixture that contains an alcohol and a ferrocenium salt; treating the mixture with a gas that includes oxygen to form a catalyst composition; combining the catalyst composition with at least one cationically polymerizable monomer to form a polymerizable composition; and thermally curing the polymerizable composition to form a polymeric material.

This polymerization method includes preparing a catalyst composition prior to being combined with a cationically polymerizable monomer (i.e., a monomer having at least one cationically polymerizable group) to form a polymerizable composition. The catalyst composition is prepared from a mixture of an alcohol and a ferrocenium salt of Formula I
(Cp)₂FeX I
where Cp is a cyclopentadienyl group that is unsubstituted or substituted with up to three substituents; and X is an anion that is a tris-(fluorinated alkylsulfonyl)methide anion, bis-(fluorinated alkylsulfonyl)imide anion, tris-(fluorinated arylsulfonyl)methide anion, tetrakis-(fluorinated aryl)borate anion, alkyl sulfonate anion, fluorinated alkyl sulfonate anion, aryl sulfonate anion, fluorinated aryl sulfonate anion, or halogen-containing complex of a metal or metalloid.

The cyclopentadienyl group in Formula I can be unsubstituted or substituted with up to three substituents. The substituents are typically selected from a group such as, for example, an alkyl, alkoxy, trialkylsilyl, triaryltin, halo, amino, fused aliphatic ring, fused aromatic ring, or combinations thereof. An alkyl substituent typically has 1 to 10 carbon atoms. An alkoxy substituent typically has 1 to 10 carbon atoms. A trialkylsilyl substituent has three alkyl groups that can be the same or different; each alkyl group typically has 1 to 10 carbon atoms. A triaryltin substituent has 3 aryl groups that can be the same or different; each aryl group typically has 6 to 30 carbon atoms and can be multiply fused. A halo is typically chloro or fluoro. A fused aliphatic ring often has 5 to 20 carbon atoms and can have multiply fused rings; a specific example is a cyclohexane ring fused to the cyclopentadienyl group. A fused aromatic ring often has 6 to 30 carbon atoms and can have multiply fused rings; a specific example is a benzene ring fused to the cyclopentadienyl group. If more than three substituents are included on the cyclopentadienyl group, the ring structure can be difficult to oxidize. Although not wanting to be bound by theory, it is believed that the ring structure can be oxidized in the process of forming the catalyst composition.

Suitable cations for the salts of Formula I include, but are not limited to, bis-(eta⁵-methylcyclopentadienyl)iron (1+), bis-(eta⁵-cyclopentadienyl)iron (1+), bis-(eta⁵-trimethylsilylcyclopentadienyl)iron (1+), (eta⁵-cyclopentadienyl)(eta⁵-methylcyclopentadienyl)iron (1+), and bis-(eta⁵-triphenyltincyclopentadienyl)iron (1+).

The anion X for some ferrocenium salts is a tris-(fluorinated alkyl)sulfonyl methide. As used herein, the term “tris-(fluorinated alkylsulfonyl)methide” refers to a monovalent anion of formula (R_{f}SO₂)₃C (1−). That is, there are three fluorinated alkylsulfonyl groups attached to a carbon atom and the resulting moiety has a negative charge. The three fluorinated alkylsulfonyl groups can be the same or different. As used herein, the term “fluorinated alkyl” refers a group of formula R_{f} where R_{f} is an alkyl having at least one of the hydrogen atoms replaced with a fluorine atom. In some fluorinated alkyl groups, all the hydrogen atoms are replaced with fluorine atoms (i.e., the fluorinated alkyl group is a perfluoroalkyl group) or all but one of the hydrogen atoms are replaced with fluorine atoms. The fluorinated alkyl groups usually have 1 to 10, 1 to 6, or 1 to 4 carbon atoms. Suitable tris-(fluorinated alkyl)sulfonyl methide anions include, but are not limited to, (CF₃SO₂)₃C (1−), (C₄F₉SO₂)₃C (1−), (C₂F₅SO₂)₃C (1−), and (CF₃SO₂)₂(C₄F₉SO₂)C (1−). These anions are further described in U.S. Pat. No. 5,554,664 (Lamanna et al.), the disclosure of which is incorporated herein by reference.

Another example of the anion X in Formula I is a tris-(fluorinated arylsulfonyl) methide. As used herein, the term “tris-(fluorinated arylsulfonyl)methide” refers to a monovalent anion of formula of (Ar_{f}—SO₂)₃—C (1−). That is, three fluorinated arylsulfonyl groups are attached to a carbon atom and the resulting moiety has a negative charge. The three fluorinated arylsulfonyl groups can be the same or different. As used herein, the term “fluorinated aryl” refers to a group of formula Ar_{f} where Ar_{f} is an aryl group having at least one of the hydrogen atoms replaced with a fluorine atom, an aryl group having at least one of the hydrogen atoms replaced with a perfluoroalkyl group, or a combination thereof. In some fluorinated aryl groups, all of the hydrogen atoms are replaced with fluorine atoms (i.e., the fluorinated aryl group is a perfluoroaryl group). In other fluorinated aryl groups, the aryl group can be substituted with a perfluormethane or perfluoroethane group. The aryl group usually has 6 to 30 carbon atoms and can include multiply fused rings. Examples of Ar_{f} groups include, but are not limited to, 4-fluorophenyl, 4-trifluoromethylphenyl, 3,5-bis-(trifluoromethyl)phenyl, and pentafluorophenyl. These anions are further described in U.S. Pat. No. 5,554,664 (Lamanna et al.), the disclosure of which is incorporated herein by reference.

The anion X for other ferrocenium salts is a bis-(fluorinated alkylsulfonyl)imide. As used herein, the term “bis-(fluorinated alkylsulfonyl)imide” refers to a monovalent anion of formula (R_{f}SO₂)₂N (1−). There are two fluorinated alkylsulfonyl groups attached to a nitrogen atom and the resulting moiety has a negative charge. The two fluorinated alkylsulfonyl groups can be the same or different and usually have 1 to 10, 1 to 6, or 1 to 4 carbon atoms. The fluorinated alkylsulfonyl group has at least one of the hydrogen atoms on the alkyl group replaced with a fluorine atom. In some fluorinated alkylsulfonyl groups, all of the hydrogen atoms or all but one of the hydrogen atoms on the alkylsulfonyl group are replaced with fluorine atoms. The anion is the reaction product of ammonia with two fluorinated alkylsulfonic acids. Exemplary bis-(fluorinated alkylsulfonyl)imide anions include, but are not limited to, (CF₃SO₂)₂N (1−), (C₂F₅SO₂)₂N (1−), (C₃F₇SO₂)₂N (1−), (C₄F₉SO₂)₂N (1−), and (CF₃SO₂)(C₄F₉SO₂)N (1−). These anions are further described in U.S. Pat. No. 5,554,664 (Lamanna et al.), the disclosure of which is incorporated herein by reference.

Still other salts according to Formula I have an anion that is an alkyl sulfonate or fluorinated alkyl sulfonate. As used herein, the term “alkyl sulfonate” refers to an anion of formula R—SO₃ (1−) where R is an alkyl group having 1 to 10, 1 to 6, or 1 to 4 carbon atoms. Suitable examples include, but are not limited to, CH₃—SO₃ (1−), C₂H₅—SO₃ (1−), C₃H₇—SO₃ (1−), and C₄H₉—SO₃ (1−). As used herein, the term “fluorinated alkyl sulfonate” refers to an alkyl sulfonate where at least one of the hydrogen atoms is replaced with a fluorine atom. In some examples, all of the hydrogen atoms are replaced with a fluorine atom (i.e., the alkyl groups are perfluoroalkyl groups) or all but one of the hydrogen atoms are replaced with a fluorine atom. Exemplary fluorinated alkyl sulfonate groups include, but are not limited to, CF₃—SO₃ (1−), C₂F₅—SO₃ (1−), C₃F₇—SO_{O}₃ (1−).

The anion of the ferrocenium salt can also be an aryl sulfonate. As used herein, the term “aryl sulfonate” refers to a group of formula Ar—SO₃ (1−) where Ar is an aryl group. The aryl group usually has 6 to 30 carbon atoms and can include multiply fused rings. The aryl group can be substituted, for example, with an alkyl, fluorinated alkyl, alkoxy, fluorinated alkoxy, or halo group. Suitable aryl sulfonate groups include, but are not limited to, benzenesulfonate, p-toluenesulfonate, p-clorobenzenesulfonate, p-fluorobenzenesulfonate, and p-trifluoromethylbenzenesulfonate.

Still other anions of the ferrocenium salt include tetrakis-(aryl)borate. As used herein, the term “tetrakis-(aryl)borate refers to an anion of formula B(Ar)₄ (1−) where there are four aryl groups attached to a boron atom and the resulting moiety has a negative charge. The aryl groups can be substituted with an alkyl, fluorinated alkyl, alkoxy, fluorinated alkoxy, or halogen group. The four aryl groups can be the same or different. Exemplary anions include tetrakis-(fluorinated aryl)borates such as tetrakis(4-fluorophenyl)borate, tetrakis(4-trifluoromethylphenyl)borate, tetrakis(3,5-bis-(trifluoromethyl)phenyl)borate, tetrakis(pentafluorophenyl)borate, and the like.

Other anions of the ferrocenium salt include halogen-containing complexes of a metal or metalloid. The halogen-containing complexes can be of Formula II
DQᵣ (1−) II
where D is a metal or metalloid of Groups 3 to 15 in the Periodic Table of Elements (IUPAC notation); Q is independently a halogen, hydroxy, phenyl, or alkyl; and r is an integer having a value of 1 to 6. In anions with multiple Q groups (i.e., r is greater than 1), the Q groups can be the same or different. In Formula II, at least one Q group is a halogen. In some anions, all of the Q groups are a halogen such as fluorine or chlorine.

Exemplary D groups in Formula II are metals or metalloids selected from copper, zinc, titanium, zirconium, indium, gallium, vanadium, chromium, manganese, iron, cobalt, nickel, boron, antimony, tin, arsenic, or phosphorous. Examples, of halogen-containing complexes include, but are not limited to, BF₄⁻, PF₆⁻, AsF₆⁻, SbF₆⁻, FeCl₄⁻, SnCl₅⁻, SbF₅OH⁻, AlCl₄⁻, GaCl₄⁻, InF₄⁻, TiF₆⁻, and ZrF₆⁻.

In some embodiments, the ferrocenium salts include unsubstituted cyclopentadienyl and an anion selected from tetrafluoroborate, hexafluorophosphate, hexafluoroarsenate, hydroxypentafluoroantimonate, hexafluoroantimonate, tetrakis(4-trifluoromethylphenyl)borate, tetrakis(3,5-bis-(trifluoromethyl)phenyl)borate, or trifluoromethanesulfonate.

In this polymerization method, a mixture is formed that includes the ferrocenium salt and an alcohol. The alcohol included in the mixture is usually an alcohol having 1 to 10 carbon atoms. Some alcohols have 1 to 8, 1 to 6, 1 to 5, 1 to 4, 1 to 3, or 1 to 2 carbon atoms. The alcohols can be mono-alcohols or diols. Suitable mono-alcohols include, but are not limited to, methanol, ethanol, 1-propanol, 2-propanol, 2-methyl-2-propanol, 1-butanol, 2-butanol, 1-pentanol, 2-pentanol, 3-pentanol, cyclopentanol, 1-hexanol, cyclohexanol, cyclohexylmethanol, 3-cyclohexyl-1-propanol, 1-heptanol, 1-octanol, 3-norbomanemethanol, and tetrahydrofurfuryl alcohol. Suitable diols include, but are not limited to, 1,2-ethanediol, 1,2-propanediol, 1,3-propanediol, 1,4-butanediol, 1,3-butanediol, 2-methyl-1,3-propanediol, 2,2-dimethyl-1 ,3-propanediol, 2-ethyl-2-methyl-1,3-propanediol, 2-ethyl-1,3-pentanediol, 1,4-dimethylolcyclohexane, 2-ethyl-1,6-hexanediol, 1,5-pentanediol, 1,6-hexanediol, and 1,8-octanediol. In some mixtures, the alcohol is methanol.

The mixture of ferrocenium salt and alcohol is treated with an oxygen containing gas to form a catalyst composition. The gas can be oxygen or oxygen combined in any suitable proportion with another gas such as argon, helium, nitrogen, or the like. In some embodiments, the gas is atmospheric air. The mixture is usually treated with the oxygen containing gas for at least 30 minutes at room temperature (i.e., about 20 to about 25° C.). In some applications, the mixture is treated for up to 1 hour, up to 2 hours, up to 3 hours, up to 4 hours, up to 6 hours, or up to 8 hours at room temperature.

Although not wanting to be bound be theory, the ferrocenium salt is believed to undergo at least partial oxidation during the treatment with an oxygen containing gas. The catalyst composition can include iron species in both a ferrous and ferric oxidation state. In some catalysts compositions, the molar ratio of ferrous to ferric can be at least 0.3 (e.g., at least 0.4 or at least 0.5). In some catalyst compositions, the molar ratio of ferrous to ferric can be up to about 4 (e.g., up to about 3 or up to about 2.5). Additionally, some of the cyclopentadienyl rings attached to iron species are believed to undergo at least partial oxidation. For example, an unsubstituted cyclopentadienyl ring can be oxidized to cyclopentadione or cyclopentenedione.

In some polymerization methods, the volatile components of the catalyst composition can be removed using any method known in the art. The volatile components include the alcohol and any volatile by-products of the treatment process. One such method of removing volatiles involves the use of a rotary evaporator. Any remaining solid residue can be washed with an alkane (e.g., pentane or hexane) or other non-polar solvent. Such a washing can remove non-polar by-products of the treatment process such as ferrocene and cyclopentadienyl derivatives.

The catalyst composition can be dissolved in any suitable solvent that is miscible with the cationically polymerizable monomers. The amount of solvent is often selected to be the minimum amount that will completely dissolve the catalyst composition. Suitable solvents include, but are not limited to, lactones such as gamma-butryolactone and gamma-valerolactone; ketones such as acetone, methyl ethyl ketone, methyl isobutyl ketone, cyclopentanone, and cyclohexanone; sulfones such as tetramethylene sulfone, 3-methylsulfolane, 2,4-dimthylsulfolane, butadiene sulfone, methyl sulfone, ethyl sulfone, propyl sulfone, butyl sulfone, methyl vinyl sulfone, 2-(methylsulfonyl)ethanol, and 2,2′-sulfonyldiethanol; sulfoxides such a dimethyl sulfoxides; cyclic carbonates such a propylene carbonate, ethylene carbonate, and vinylene carbonate; carboxylic acid esters such as ethyl acetate, methyl cellosolve, and methyl formate; and other solvents such as methylene chloride, nitromethane, acetonitrile, glycol sulfite, and 1,2-dimethoxyethane.

The catalyst composition can, in some applications, be adsorbed onto an inert support such as silica, alumina, or clay. The adsorption of a catalyst composition onto an inert support is further described in U.S. Pat. No. 4,677,137 (Berry et al.), the disclosure of which is incorporated herein by reference.

The catalyst composition is combined with at least one cationically polymerizable monomer to form a polymerizable composition. Suitable cationically polymerizable monomers include ethylenically unsaturated compounds (e.g., monoolefins, diolefins, vinyl ethers, and vinyl esters) and heterocyclic compounds.

Exemplary monoolefins and diolefins that can be cationically polymerized include, but are not limited to, isobutylene, butadiene, isoprene, styrene, α-methylstyrene, divinylbenzene, N-vinylpyrrolidone, N-vinylcarbazole, and acrolein. Exemplary vinyl esters include, but are not limited to, vinyl acetate and vinyl stearate. The vinyl ether containing monomers can be alkyl vinyl ethers such as methyl vinyl ether, ethyl vinyl ether, tert-butyl vinyl ether, and isobutyl vinyl ether; trimethylopropane trivinyl ether; triethylene glycol divinyl ether such as those commercially available from International Specialty Products (Wayne, N.J.) under the trade designation “RAPI-CURE DVE-3”; 1,4-dimethylolcyclohexane divinyl ether such as those commercially available from International Specialty Products under the trade designation “RAPI-CURE CHVE”; and resins commercially available from Morflex, Inc. under the trade designation “VECTOMER 1312”, “VECTOMER 4051”, “VECTOMER 4010”, and “VECTOMER 4060”; and equivalents thereof available from other manufacturers. Other vinyl ethers can be cyclic vinyl ethers such as 3,4-dihydro-2-formyl-2H-pyran and the 3,4-dihydro-2H -pyran-2-carboxylic acid ester of 2-hydroxymethyl-3,4-dihydro-2H-pyran.

Exemplary heterocyclic compounds that can be cationically polymerized include, but are not limited to, ethylene oxide, propylene oxide, epichlorohydrin, glycidyl ethers of monohydric alcohols (e.g., n-butyl glycidyl ether and n-octyl glycidyl ether), glycidyl ethers of monohydric phenols (e.g., phenyl glycidyl ether and cresyl glycidyl ether), glycidyl acrylate, glycidyl methacrylate, styrene oxide, and cyclohexane oxide. Other exemplary monomers include oxetanes such as 3,3-dimethyloxetane and 3,3-di(chloromethyl)oxetane; tetrahydrofuran; dioxolanes, trioxolanes, and 1,3,6-trioxacyclooctane; spiroorthocarbonates; lactones such as β-propiolactone, γ-valerolactone, and ε-caprolactone; thiranes such as ethylene sulfide and propylene sulfide; azetidines such as N-acylazetidines (e.g., N-benzoylazetidine), and adducts of azetidine with diisocyanates (e.g., adducts of azetidine with toluene-2,4-diisocyanate, toluene-2,6-diisocyanate, and 4,4′-diaminodiphenylmethane diisocyanate); epoxy monomers; and linear or branched polymers with glycidyl groups in side chains (e.g., homopolymers and copolymers of acrylate and methacrylate glycidyl esters).

In many embodiments of the polymerizable composition, the cationically polymerizable monomer includes epoxy monomers. The epoxy monomers often have, on average, at least two oxirane rings per molecule and may also be referred to as “epoxides.” Suitable epoxy monomers include 1,2-, 1,3-, and 1,4-epoxides. Such materials may be, for example, aliphatic, alicyclic, heterocyclic, cycloaliphatic, or aromatic and may further be combinations thereof.

Epoxides may be liquid or solid or blends thereof, blends being especially useful in providing tacky adhesive films. The molecular weight of the epoxy monomer may vary from about 74 to about 100,000 or more. That is, some of the epoxides are polymeric materials. Mixtures of various epoxy monomers may also be used in the adhesive compositions of the present invention. The polymeric epoxides include, but are not limited to, linear polymers having terminal epoxy groups (for example, a diglycidyl ether of a polyoxyalkylene glycol), polymers having skeletal oxirane units (for example, polybutadiene polyepoxide), and polymers having pendent epoxy groups (for example, a glycidyl methacrylate polymer or copolymer).

Some epoxy monomers suitable for use in the polymerizable composition include glycidyl ether monomers and have a structure as shown below: 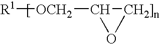
where R¹ is aliphatic (e.g., an alkyl group), aromatic (e.g., an aryl group), or a combination thereof; and n is an integer from about 1 to about 6. Some epoxy monomers having a structure as shown above include, but are not limited to, glycidyl ethers of polyhydric phenols obtained by reacting a polyhydric phenol with an excess of chlorohydrin such as epichlorohydrin. For example, the epoxide can be a diglycidyl ether of 2,2-bis-(4-hydroxyphenyl)propane (Bisphenol A). Further examples of epoxides of this type are described in U.S. Pat. No. 3,642,937 (Deckert et al.) and U.S. Pat. No. 3,746,068 (Deckert et al.), the disclosures of which are incorporated herein by reference.

A number of commercially available epoxy monomers can be used. Epoxides that are readily available include, but are not limited to, octadecylene oxide; epichlorohydrin; styrene oxide; vinylcyclohexene oxide; glycidol; glycidyl methacrylate; diglycidyl ether of bisphenol A (for example, those available under the trade designations “EPON 815C”, “EPON 813”, “EPON 828”, “EPON 1004F”, and “EPON 1001F” from Resolution Performance Products, Houston, Tex.); and diglycidyl ether of bisphenol F (for example, those available under the trade designations “ARALDITE GY281” from Ciba Specialty Chemicals Holding Company, Basel, Switzerland, and “EPON 862” from Resolution Performance Products).

Other exemplary epoxy monomers include vinyl cyclohexene dioxide (available from SPI Supplies, West Chester, Pa.); 4-vinyl-1-cylcohexene diepoxide (available from Aldrich Chemical Co., Milwaukee, Wis.); 3,4-epoxycyclohexylmethyl-3,4-epoxycyclohexene carboxylate (for example, one available under the trade designation “CYRACURE UVR-6110” from Dow Chemical Co.); 3,4-epoxy-6-methylcylcohexylmethyl-3,4-epoxy-6-methyl-cylcohexane carboxylate; 2-(3,4-epoxycyclohexyl-5,5-spiro-3,4-epoxy) cyclohexane-metadioxane; bis(3,4-epoxycyclohexylmethyl) adipate (for example, one available under the trade designation “CYRACURE UVR-6128” from Dow Chemical Co.); bis(3,4-epoxy-6-methylclyclohexylmethyl)adipate; 3,4-epoxy-6-methylcyclohexane carboxylate; and dipentene dioxide.

Still other exemplary epoxy monomers include epoxidized polybutadiene (for example, one available under the trade designation “POLY BD 605E” from Sartomer Co., Inc., Exton, Pa.); epoxy silanes (for example, 3,4-epoxycylclohexylethyltrimethoxysilane and 3-glycidoxypropyltrimethoxysilane, commercially available from Aldrich Chemical Co., Milwaukee, Wis.); flame retardant epoxy monomers (for example, one available under the trade designation “DER-542”, a brominated bisphenol type epoxy monomer available from Dow Chemical Co., Midland, Mich.); 1,4-butanediol diglycidyl ether (for example, one available under the trade designation “ARALDITE RD-2” from Ciba Specialty Chemicals); hydrogenated bisphenol A-epichlorohydrin based epoxy monomers (for example, one available under the trade designation “EPONEX 1510” from Resolution Performance Products); polyglycidyl ether of phenol-formaldehyde novolak (for example, one available under the trade designation “DEN-431” and “DEN-438” from Dow Chemical Co.); and epoxidized vegetable oils such as epoxidized linseed and soybean oils available under the trade designations “VIKOLOX” and “VIKOFLEX” from Atofina Chemicals (Philadelphia, Pa.).

Additional suitable epoxy monomers include alkyl glycidyl ethers commercially available from Resolution Performance Products (Houston, Tex.) under the trade designation “HELOXY”. Exemplary monomers include “HELOXY MODFIER 7” (a C₈-C₁₀ alky glycidyl ether), “HELOXY MODIFIER 8” (a C₁₂-C₁₄ alkyl glycidyl ether), “HELOXY MODIFER 61” (butyl glycidyl ether), “HELOXY MODIFER 62” (cresyl glycidyl ether), “HELOXY MODIFER 65” (p-tert-butylphenyl glycidyl ether), “HELOXY MODIFER 67” (diglycidyl ether of 1,4-butanediol), “HELOXY 68” (diglycidyl ether of neopentyl glycol), “HELOXY MODIFER 107” (diglycidyl ether of cyclohexanedimethanol), “HELOXY MODIFER 44” (trimethylol ethane triglycidyl ether), “HELOXY MODIFIER 48” (trimethylol propane triglycidyl ether), “HELOXY MODIFER 84” (polyglycidyl ether of an aliphatic polyol), and “HELOXY MODIFER 32” (polyglycol diepoxide).

The polymerizable composition can include any amount of the catalyst composition that can effectively initiate the polymerization reaction of the monomer. The polymerizable composition typically includes at least 0.1 weight percent of the catalyst composition on a dry weight basis. The dry weight is the weight of the composition minus the weight of any solvent that may be present. The weight percent of the catalyst composition in the polymerizable composition can be calculated by multiplying the dry weight of the catalyst composition by 100 and dividing by the total dry weight of the polymerizable composition. Lower catalyst amounts can be used but the reaction times may be unacceptably long or the percent cure may be unacceptably low.

The polymerizable composition typically includes no greater than 2 weight percent catalyst composition on a dry weight basis. Although higher levels of the catalyst composition can be used, the reaction time may not decrease further and the percent cure may not increase further with additional amounts. When the catalyst composition (i.e., dry weight) is 0.1 to 2 weight percent of the polymerizable composition, the time needed to obtain a designated percent cure tends to decrease with an increase in the amount of the catalyst composition. Similarly, when the catalyst composition amount is in this range, the percent cure obtained within a designated time tends to increase with an increase in the amount of the catalyst composition.

As used herein, the term “percent cure” refers to the percent conversion of the monomer to a polymeric or higher molecular weight material. The percent cure can be determined, in some applications, by measuring the percent unreacted cationically polymerizable groups. That is, the percent cure is equal to 100 percent minus the percent unreacted cationically polymerizable groups. In the case of a monomer having an epoxy group, the amount of unreacted epoxy groups can be determined, for example, using infrared spectroscopy (e.g., by measuring the absorbance at about 4531 cm⁻¹).

This polymerization method can be used in a closed environment such as within a mold or between two layers in a laminated structure.

A gas that includes oxygen can be introduced into the polymerizable composition. The introduction of a gas that includes oxygen usually can increase the rate of the polymerization reaction. For example, the rate of a reaction conducted in the presence of oxygen can be at least 1.25 times, at least 1.5 times, at least 2 times, at least 3 times, at least 4 times, at least 5 times, or at least 10 times as fast compared to a reaction conducted in the absence of oxygen (e.g., in nitrogen). The reaction rate as well as the reaction rate increase in the presence of oxygen usually depends on the particular cationically polymerizable monomer chosen. The reaction rate can be determined by measuring the time needed to form a gel after the catalyst composition and the cationically polymerizable monomer have been combined. Alternatively, the reaction rate can be determined by measuring the percent cure.

In a second aspect, another method of preparing a polymer is provided. A polymerizable composition is formed that includes a monomer having at least one cationically polymerizable group, methanol, and a ferrocenium salt of Formula I.
(Cp)₂FeX I
In Formula I, Cp is a cyclopentadienyl group that is unsubstituted or substituted with up to three substituents; and X is an anion that is a tris-(fluorinated alkylsulfonyl)methide, bis-(fluorinated alkylsulfonyl)imide, tris-(fluorinated arylsulfonyl)methide, tetrakis-(fluorinated aryl)borate, alkyl sulfonate, fluorinated alkyl sulfonate, aryl sulfonate, fluorinated aryl sulfonate, or halogen-containing complex of a metal or metalloid. The polymerizable composition has a molar ratio of cationically polymerizable groups in the monomer to methanol that is at least 12:1. The polymerizable composition is thermally cured using a process that includes exposing the polymerizable composition to a gas that contains oxygen.

In this method, the catalyst is formed in the presence of the cationically polymerizable monomer after the introduction of a gas containing oxygen. The catalyst is derived from the ferrocenium salt and is usually soluble in the cationically polymerizable monomer. The rate of polymerization for reactions in which the catalyst is formed in the presence of the polymerizable monomers tends to be slower than for reactions in which the catalyst composition is formed before combination with the cationically polymerizable monomers.

The molar ratio of the cationically polymerizable groups to methanol is at least 12:1. If the methanol concentration exceeds this amount, the alcohol could cause polymer chain termination, reduce the amount of crosslinking, result in the formation of two phases (i.e., the methanol can phase separate from the cationically polymerizable monomers), or combinations thereof.

In some applications, the molar ratio of the reactive groups in the cationically polymerizable monomer to methanol is at least 15:1, at least 20:1, at least 25:1, at least 30:1, at least 40:1, at least 50:1, or at least 60:1. The molar ration is usually less than 200:1. In some applications, the molar ratio is less than 175:1, less than 150:1, less than 125:1, less than 100:1, or less than 80:1.

The polymerizable compositions described herein can include a chain extender such as a polyol, a dihydridic phenol, or a diamine. Suitable polyols typically have an average molecular weight (Mₙ) of at least 200 g/mole and have at least two hydroxy groups. Exemplary polyols include materials in the molecular weight (Mₙ) range of 200 to 20,000 available from Dow Chemical Co., Midland, Mich. under the trade designation “CARBOWAX”; carpolactone polyols in the molecular weight (Mₙ) range of 200 to 5,000 such as materials available from Dow Chemical Co., Midland, Mich. under the trade designation “TONE”; polytetramethylene ether glycol in the molecular weight (Mₙ) range of 200 to 4,000 such as materials available from DuPont, Wilmington, Del. under the trade designation “TERATHANE” and from BASF, Mount Olive, N.J. under the trade designation “POLYTHF 250”; polyethylene glycol such as material available from Dow Chemical Co., Midland, Mich. under the trade designation “PEG 200”; hydroxy-terminated polybutadiene resins such as materials from Atofina, Philadelphia, Pa. under the trade designation “POLYBD”; phenoxy resins such as those commercially available from Phenoxy Associates, Rock Hill, S.C.; and similar materials supplied by other manufacturers. Suitable dihydridic phenols include, but are not limited to catechols (e.g., catechol, 1,2-dihydroxy-4-methylbenzene, 4-tert-butylcatechol, 3-methoxycatechol, and 3-methylcatechol), resorcinols, dihydroxynaphthalenes, and bisphenols (e.g., Bisphenol A and Bisphenol F). Suitable amine include, but are not limited to, polymeric diamines.

Elastomeric modifiers (i.e., toughening agents) can be included in the polymerizable compositions described herein. Such materials generally have both a rubbery phase and a thermoplastic phase. Exemplary elastomeric modifiers include, but are not limited to, graft copolymers having a polymerized diene core (e.g., polybutadiene or a mixture of a polymerized mixture of butadiene and styrene) and a polyacrylate or polymethacrylate shell.

The polymerizable composition described herein can include various adjuvants such as colorants, pigments, abrasive granules, stabilizers, antioxidants, flow agents, body agents, flatting agents, inert fillers, binders, blowing agents, fungicides, bactericides, surfactants, plasticizers, and other additives known to those skilled in the art. These adjuvants, if added, can be added in an amount effective for their intended purpose.

The presence of a small amount of water can affect the rate of the polymerization reaction of the polymerizable compositions described herein. Usually, water is not added but is present in the various components of the polymerizable composition such as in the cationically polymerizable monomer, in the catalyst composition, in solvents that may be present, in a gas introduced into the polymerizable composition, or in various adjuvants. The polymerization reaction may be slower if all the components of the polymerizable composition are rigorously dried. The amount of water is typically in the range of about 0.01 to about 3 weight percent based on the weight of the polymerizable composition. In some applications, the polymerizable composition contains about 0.05 to about 3 weight percent, about 0.05 to about 2 weight percent water, or about 0.5 to about 1 weight percent water.

The polymerization reaction of the polymerizable compositions described herein can proceed at room temperature (e.g., about 20° C. to about 25° C.) or at an elevated temperature (e.g., up to about 200° C.). In some applications, the polymerization reaction is conducted at temperatures up to about 175° C., up to about 150° C., up to about 125° C., or up to about 115° C. Suitable sources of heat include induction heating coils, ovens, hot plates, heat guns, infrared sources, lasers, microwaves, and the like.

Using a higher reaction temperature often can increase the rate of polymerization. The formed polymeric material tends to have a higher glass transition temperature in a shorter time when a higher reaction temperature is used. Likewise, a higher percent cure can often be obtained within the same amount of time by using a higher reaction temperature. The formed polymeric material tends to have a higher glass transition temperature in the same amount of time when a higher reaction temperature is used.

The polymerizable compositions described herein can be applied to a substrate prior to curing. Suitable substrates include, but are not limited to, metals (e.g., aluminum, copper, zinc, nickel, steel, iron, silver, and gold), glass, paper, wood, cloth, polymeric film, ceramics, cellulosics (e.g., cellulose acetate), and the like. Suitable polymeric films can be prepared from thermoplastic polymers or thermoset polymers that include, for example, polyethylene terephthalate, polyvinyl chloride, polypropylene, polyethylene, and the like.

The polymeric material formed can be a thermoset, cured polymer prepared from epoxy monomers. In other applications the polymeric material can be an elastomeric material (e.g., the polymeric material can be used as elastomeric gasket materials). The polymeric material can include fillers such as a material that absorbs at least some actinic radiation such as ultraviolet, infrared, or visible radiation.

In some applications, the polymeric material formed is an adhesive that can be used to bond one substrate to another substrate or to bond one article to another article. The substrate or articles can be clear, colored, opaque, or reflective. The substrate or article can include pigments or dyes that absorb actinic radiation such as ultraviolet, infrared, or visible radiation.

The polymeric material can be an epoxy structural adhesive that can be used, for example, for bonding articles in various aerospace, building construction, and vehicular applications. Additionally, the low-temperature polymeric materials can be used as an adhesive in various medical applications such as in medical devices.

The ferrocenium-derived catalyst included in or formed in the above described polymerization methods can be used to prepare a polymeric material with a higher percent cure within a shorter time and at a lower reaction temperature compared to polymerization methods based on using untreated ferrocenium salts as the catalyst. Low temperature curing is useful for applications, for example, on thermoplastic substrates that cannot be heated without losing their molded shape.

The cured polymeric material formed in the above described polymerization methods can have a higher glass transition temperature with improved chemical stability and moisture resistance compared to the commonly used polymeric material prepared from acrylic monomers.

In a third aspect, a polymerizable composition is provided that includes a monomer having a cationically polymerizable group, methanol, and a ferrocenium salt of Formula I.
(Cp)₂FeX I
The polymerizable composition has a molar ratio of cationically polymerizable groups in the monomer to methanol that is at least 12:1. In Formula I, Cp is a cyclopentadienyl group that is unsubstituted or substituted with up to three substituents; and X is an anion that is a tris-(fluorinated alkylsulfonyl)methide, bis-(fluorinated alkylsulfonyl)imide, tris-(fluorinated arylsulfonyl)methide, tetrakis-(fluorinated aryl)borate, alkyl sulfonate, fluorinated alkyl sulfonate, aryl sulfonate, fluorinated aryl sulfonate, or halogen-containing complex of a metal or metalloid.

In some polymerizable compositions, the molar ratio of the reactive groups in the cationically polymerizable monomer to methanol is at least 15:1, at least 20:1, at least 25:1, at least 30:1, at least 40:1, at least 50:1, or at least 60:1. The molar ration is usually less than 200:1. In some applications, the molar ratio is less than 175:1, less than 150:1, less than 125:1, less than 100:1, or less than 80:1.

The foregoing describes the invention in terms of embodiments foreseen by the inventor for which an enabling description was available, notwithstanding that insubstantial modifications of the invention, not presently foreseen, may nonetheless represent equivalents thereto.

### EXAMPLES

Unless otherwise noted, all solvents and reagents were or can be obtained from Aldrich Chemical Co., Milwaukee, Wis.

Unless otherwise noted, solvents and reagents were not dry and were not degassed or deoxygeneated before use.

As used herein,

“ERL 4221” refers to a mixture that contains vinylcyclohexene dioxide, which is available from SPI Supplies, West Chester, Pa.;

“EPON 828” refers to a difunctional bisphenol A epichlorohydrin derived epoxy monomer, which is available from Resolution Performance Products, Houston, Tex.;

“CELLOXIDE 2081” refers to a modified epoxy monomer, available from Daicel Chemical Industries, LTD, Tokyo, Japan;

“VIKOFLEX 9080” refers to an epoxidized vegetable oil that was obtained from Atofina Chemicals Inc., Philadelphia, Pa.;

“TPTZ” refers to 2,4,6-tri-2-pyridyl-1,3,5-triazine;

“DSC” refers to differential scanning calorimetry; and

“PC” refers to propylene carbonate.

### Example 1

Preparation of Ferrocenium-Derived Catalyst

A 0.005M solution of ferrocenium hexafluoroantimonate in methanol was magnetically stirred in air at room temperature for approximately 4 hours. The volatile components were removed using a rotary evaporator and then the dark product residue was washed with pentane. The pentane-insoluble portion of the product residue was dried under vacuum overnight at room temperature to afford the ferrocenium-derived catalyst. The catalyst was stored in a nitrogen-filled glove box.

### Examples 2-3

Polymerization of Epoxy ERL 4221 with a Ferrocenium-Derived Catalyst

In a nitrogen-filled glove box, a screw cap vial was charged with propylene carbonate (0.0868 g) and the ferrocenium-derived catalyst of Example 1 (0.0102 g). After the catalyst was dissolved in the propylene carbonate, ERL 4221 (2.01 g) was added to the vial. The ERL 4221 had first been subjected to successive evacuation and nitrogen gas refill cycles in a flask to remove atmospheric gases from the epoxy. The vial was sealed with poly(tetrafluoroethylene) thread sealing tape and a plastic cap and was then removed from the glove box. The mixture in the vial was mixed using a model DAC mixer (available from Dantco Mixers Corp., Paterson, N.J.) for approximately 60 seconds at 3300 rpm. The vial was then taken into the glove box and the mixture was divided between two vials.

For Example 2, one of the vials was left uncapped in the nitrogen-filled glove box. For Example 3, the other vial was taken out of the glove box and was left uncapped as the mixture was exposed to the laboratory atmosphere. The mixtures were monitored for gel formation, which was determined to be the time at which the mixtures no longer flowed around a wooden applicator when it was pushed into the material in the vial, i.e., the time at which the material in the vial moved as a single gelled mass in the vial. The time to gel formation in Example 2 was determined to be greater than 35 minutes. The time to gel formation in Example 3 was determined to be approximately 8 minutes

### Examples 4-5

Polymerization of Epoxy EPON 828 with Ferrocenium-Derived Catalyst

In a nitrogen-filled glove box, a screw cap vial was charged with propylene carbonate (0.0804 g) and the ferrocenium-derived catalyst of Example 1 (0.0107 g). After the catalyst was dissolved in the propylene carbonate, EPON 828 (2.05 g) was added to the vial. The EPON 828 had first been subjected to successive evacuation and nitrogen gas refill cycles in a flask to remove atmospheric gases from the epoxy. The vial was sealed with poly(tetrafluoroethylene) thread sealing tape and a plastic cap and was then removed from the glove box. The mixture in the vial was mixed using a DAC mixer for approximately 60 seconds at 3300 rpm. The vial was then taken into the glove box and the mixture was divided between two shallow aluminum dishes.

For Example 4, one of the dishes was left in the nitrogen-filled glove box and was heated on a hot plate to a temperature of 100° C. For Example 5, the other dish was taken out of the glove box and the mixture was exposed to the laboratory atmosphere as this dish was heated on a hot plate to a temperature of 100° C. The mixtures were monitored for gel formation as described in Examples 2-3. The time to gel formation in Example 4 was determined to be approximately 5 minutes. The time to gel formation in Example 5 was determined to be approximately 5 minutes.

### Examples 6-7

Polymerization of Epoxy CELLOXIDE 2081 with Ferrocenium-Derived Catalyst

In a nitrogen-filled glove box, a screw cap vial was charged with propylene carbonate (0.063 g) and the ferrocenium-derived catalyst of Example 1 (0.010 g). After the catalyst was dissolved in the propylene carbonate, CELLOXIDE 2081 (2.00 g) was added to the vial. The CELLOXIDE 2081 had first been subjected to successive evacuation and nitrogen gas refill cycles in a flask to remove atmospheric gases from the epoxy. The vial was sealed with poly(tetrafluoroethylene) thread sealing tape and a plastic cap and was then removed from the glove box. The mixture in the vial was mixed using a DAC mixer for approximately 60 seconds at 3300 rpm. The vial was then taken into the glove box and the mixture was divided between two vials.

For Example 6, one of the vials was left uncapped in the nitrogen-filled glove box. For Example 7, the other vial was taken out of the glove box and was left uncapped as the mixture was exposed to the laboratory atmosphere. The mixtures were monitored for gel formation as described in Examples 2-3. The time to gel formation in Example 6 was determined to be greater than 100 minutes. The time to gel formation in Example 7 was determined to be approximately 10 minutes.

### Examples 8-9

Polymerization of Epoxy VIKOFLEX 9080 with Ferrocenium-Derived Catalyst

In a nitrogen-filled glove box, a screw cap vial was charged with propylene carbonate (0.068 g) and the ferrocenium-derived catalyst of Example 1 (0.0103 g). After the catalyst was dissolved in the propylene carbonate, VIKOFLEX 9080 (1.98 g) was added to the vial. The VIKOFLEX 9080 had first been subjected to successive evacuation and nitrogen gas refill cycles in a flask to remove atmospheric gases from the epoxy. The vial was sealed with poly(tetrafluoroethylene) thread sealing tape and a plastic cap and was then removed from the glove box. The mixture in the vial was mixed using a DAC mixer for approximately 60 seconds at 3300 rpm. The vial was then taken into the glove box and the mixture was divided between two vials.

For Example 8, one of the vials was left uncapped in the nitrogen-filled glove box. For Example 9, the other vial was taken out of the glove box and was left uncapped as the mixture was exposed to the laboratory atmosphere. The mixtures were monitored for gel formation as described in Examples 2-3. The time to gel formation in Example 8 was determined to be greater than 48 hours. The time to gel formation in Example 9 was determined to be approximately 24 hours.

### Example 10

Polymerization of Epoxy ERL 4221 with Ferrocenium-Derived Catalyst Formed in situ

In a nitrogen-filled glove box, a screw cap vial was charged with propylene carbonate (0.055 g) and ferrocenium hexafluoroantimonate (0.010 g). After the ferrocenium salt was dissolved in the propylene carbonate, a mixture of 0.36 weight percent methanol in ERL 4221 (2.0 g total weight of epoxy and methanol mixture) was added to the vial. The ERL 4221 had first been subjected to successive evacuation and nitrogen gas refill cycles in a flask to remove atmospheric gases from the epoxy. The vial was sealed with poly(tetrafluoroethylene) thread sealing tape and a plastic cap and was then removed from the glove box. The mixture in the vial was mixed using a DAC mixer for approximately 60 seconds at 3300 rpm.

The vial was then taken into the glove box and the mixture was divided between two vials (for Example 10 and Comparative Example 1). For Example 10, the vial was taken out of the glove box and was left uncapped as the mixture was exposed to the laboratory atmosphere. The mixture was monitored for gel formation as described in Examples 2-3. The time to gel formation in Example 10 was determined to be approximately 30 minutes.

### Comparative Example 1

Polymerization of Epoxy ERL 4221 with Ferrocenium Catalyst

In a nitrogen-filled glove box, a screw cap vial was charged with propylene carbonate (0.055 g) and ferrocenium hexafluoroantimonate (0.010 g). After the ferrocenium salt was dissolved in the propylene carbonate, a mixture of 0.36 weight percent methanol in ERL 4221 (2.0 g total weight of epoxy and methanol mixture) was added to the vial. The ERL 4221 had first been subjected to successive evacuation and nitrogen gas refill cycles in a flask to remove atmospheric gases from the epoxy. The vial was sealed with poly(tetrafluoroethylene) thread sealing tape and a plastic cap and was then removed from the glove box. The mixture in the vial was mixed using a DAC mixer for approximately 60 seconds at 3300 rpm.

The vial was then taken into the glove box and the mixture was divided between two vials (for Example 10 and Comparative Example 1). For Comparative Example 1, the vial was left uncapped in the nitrogen-filled glove box. The mixture was monitored for gel formation as described in Examples 2-3. The time to gel formation in Comparative Example 1 was determined to be approximately 20 hours.

### Examples 11-14

Polymerization of Epoxy ERL 4221 with a Ferrocenium-Derived Catalyst Formed in situ: Variation in Amount of Methanol

For Examples 11-14, each of four plastic vials was charged with ferrocenium hexafluoroantimonate and propylene carbonate as indicated in Table 1. To each vial was then added 2.0 grams of a mixture of methanol and ERL 4221, each mixture having the relative weight percentage of methanol as indicated in Table 1. Each sample was then mixed using a DAC mixer for approximately 1 minute at 3300 rpm. The mixtures were monitored for gel formation as described in Examples 2-3. The data are given in Table 1.

TABLE 1
Examples 11-14

| | | | Wt. Percent | |
|---|---|---|---|---|
| Ex- | Wt. Ferrocenium | | Methanol in | Approximate |
| ample | Hexafluoroantimonate | Wt. PC | ERL 4221 | Gel Time |
| 11 | 0.0100 g | 0.0689 g | 0.38% | 4 minutes |
| 12 | 0.0100 g | 0.0817 g | 0.78% | 4 minutes |
| 13 | 0.0102 g | 0.0640 g | 1.2% | 4 minutes |
| 14 | 0.0100 g | 0.0659 g | 1.5% | <1 minute |

### Examples 15-18

Determination of Fe²⁺ and Fe³⁺ in Ferrocenium-Derived Catalysts

Separate solutions of ferrocenium hexafluoroantimonate (Example 15), ferrocenium hexafluorophosphate (Example 16), ferrocenium tetrakis(3,5-bis(trifluoromethyl)phenyl)borate (Example 17), and ferrocenium tetrafluoroborate (Example 18) were made at concentrations of 0.0002 molar in methanol that contained approximately 0.1 weight percent water. Each mixture was magnetically stirred as it was exposed to the laboratory atmosphere for approximately 4 hours. A 2 mL aliquot of each mixture was transferred to separate vials that each contained approximately 3-5 mg of TPTZ. A portion of each of these mixtures was transferred to separate 0.2 cm cuvettes (available from NSG Precision Cells, Farmingdale, N.Y.) and the absorbance of each solution at 593 nm was measured using a Model HP8452A Diode Array Spectrophotometer (available from Agilent Technologies, Palo Alto, Calif.). The absorbance of each aliquot at 593 nm is proportional to the concentration of Fe²⁺ in each mixture.

The solution in the cuvette was transferred back to the corresponding vial and then ascorbic acid (5-7 mg) was added to each vial. A portion of each solution was then transferred to a 0.2 cm cuvette and the absorbance of each of these solutions at 593 nm was measured. The concentration of Fe³⁺ is proportional to the difference in absorbance of each sample before and after treatment with ascorbic acid. The ratio of Fe²⁺ to Fe³⁺ for each sample is given in Table 2.

TABLE 2
Examples 15-18

| Example | Ferrocenium Salt | Fe²⁺/Fe³⁺ Ratio |
|---|---|---|
| 15 | hexafluoroantimonate | 1.30 |
| 16 | hexafluorophosphate | 2.63 |
| 17 | tetrakis(3,5- | 2.36 |
| | bis(trifluoromethyl)phenyl)borate | |
| 18 | tetrafluoroborate | 0.727 |

### Examples 19-24

Polymerization of Epoxy Compositions at 115° C. Using Different Concentrations of a Ferrocenium-Derived Catalyst

In each of four plastic vials, propylene carbonate and the ferrocenium-derived catalyst of Example 1, in the quantities given in Table 3, were combined. Then EPON 828, in the quantities given in Table 3, was added to each vial to provide the compositions of Examples 19-24. Each mixture was mixed using a model DAC mixer for approximately 60 seconds at 3300 rpm. Each mixture was spread in a silicone rubber mold and was covered with a sheet of silicone-coated poly(ethylene terephthalate) (PET) release liner, such as those available under the trade designation “CLEARSIL”, available from CPFilms, Martinsville, Va., to give samples of the polymerizable compositions that were approximately 0.014 inches thick. The samples were then placed in an oven and were heated at 115° C. The approximate level of residual epoxy in each sample after time intervals of 15, 30, 60, and 120 minutes at 115° C. was determined by infrared spectrometry using a model Nexus 870 Fourier Transform Infrared spectrophotometer (available from ThermoNicolet, Waltham, Mass.) by comparing the absorbance at 4531 cm⁻¹ of each sample to that of a control sample of epoxy monomer that did not contain the catalyst. The percent residual epoxy is proportional to the ratio of the absorbance of the exemplary sample and the control sample. The data are given in Table 3.

TABLE 3
Examples 19-24

| | | | | % | % | % | % |
|---|---|---|---|---|---|---|---|
| | Wt. | Wt. | Wt. | Residual | Residual | Residual | Residual |
| Example | Catalyst | PC | EPON 828 | 15 min | 30 min | 60 min | 120 min |
| 19 | 0.0107 g | 0.074 g | 8.05 g | 50% | 39% | 32% | 29% |
| 20 | 0.011 g | 0.070 g | 4.10 g | 43% | 29% | 21% | 20% |
| 21 | 0.0103 g | 0.112 g | 2.00 g | 48% | 26% | 12% | 8% |
| 22 | 0.0104 g | 0.123 g | 1.47 g | 46% | 26% | 10% | 4% |
| 23 | 0.0103 g | 0.112 g | 1.26 g | 42% | 23% | 9% | 3% |
| 24 | 0.0099 g | 0.111 g | 1.00 g | 42% | 21% | 8% | 2% |

### Examples 25-27

Polymerization of Epoxy Compositions Monitored by Temperature Modulated DSC

Three mixtures of the ferrocenium-derived catalyst of Example 1, propylene carbonate, and EPON 828, each having a composition as indicated in Table 4, were spread in individual silicone rubber molds. Each mold was then covered with a sheet of silicone-coated release liner as described in Examples 19-24. Each sample was placed in an oven and was heated according to the parameters indicated in Table 4. Each sample was then analyzed using a Model DSC 2920 temperature modulated differential scanning calorimeter, available from TA Instruments, New Castle, Del., to determine the glass transition temperature. The data are given in Table 4.

TABLE 4
Examples 25-27

| | | | Wt. | | | |
|---|---|---|---|---|---|---|
| Ex- | Wt. | | EPON | Temper- | | |
| ample | Catalyst | Wt. PC | 828 | ature | Time | Tg |
| 25 | 0.0103 g | 0.0634 g | 2.07 g | 85° C. | 60 min | 57° C. |
| 26 | 0.0098 g | 0.0487 g | 2.06 g | 100° C. | 30 min | 71° C. |
| 27 | 0.0097 g | 0.0404 g | 1.99 g | 125° C. | 15 min | 79° C. |

### Examples 28-31

Polymerization of Epoxy Compositions Monitored by Infrared Spectrometry

Four mixtures of the ferrocenium-derived catalyst of Example 1, propylene carbonate, and EPON 828, each having a composition as indicated in Table 5 were spread onto four sheets of silicone-coated poly(ethylene terephthalate) (PET) release liner, such as those available under the trade designation “CLEARSIL”, available from CPFilms, Martinsville, Va. to provide samples of the polymerizable compositions that were 0.014 inches thick. Each sample was covered with another sheet of silicone-coated PET and was placed in an oven at the temperature indicated in Table 5 for either 30 minutes (Example 28) or 60 minutes (Examples 29-31). The approximate level of residual epoxy in each sample after the time indicated in Table 5 was determined by infrared spectrometry as described in Examples 19-24. The data are given in Table 5.

TABLE 5
Examples 28-31

| | | | | | Approx. |
|---|---|---|---|---|---|
| | Wt. | | Wt. | | Residual |
| Example | Catalyst | Wt. PC | EPON 828 | Temperature | Epoxy |
| 28 | 0.0103 g | 0.0634 g | 2.07 g | 85° C. | 45% |
| 29 | 0.0103 g | 0.0634 g | 2.07 g | 85° C. | 24% |
| 30 | 0.0098 g | 0.0487 g | 2.06 g | 100° C. | 21% |
| 31 | 0.0101 g | 0.0650 g | 2.17 g | 115° C. | 14% |

1. A method of preparing a polymer, said method comprising:
forming a mixture comprising an alcohol and a ferrocenium salt of Formula I
(Cp)₂FeX I
wherein
Cp is a cyclopentadienyl group that is unsubstituted or substituted with up to three substituents; and
X is an anion that is a tris-(fluorinated alkylsulfonyl)methide, bis-(fluorinated alkylsulfonyl)imide, tris-(fluorinated arylsulfonyl)methide, tetrakis-(fluorinated aryl)borate, alkyl sulfonate, fluorinated alkyl sulfonate, aryl sulfonate, fluorinated aryl sulfonate, or halogen-containing complex of a metal or metalloid;
treating the mixture with a gas comprising oxygen to form a catalyst composition;
combining the catalyst composition and at least one cationically polymerizable monomer to form a polymerizable composition; and
thermally curing the polymerizable composition.

2. The method of claim 1, wherein the alcohol has 1 to 4 carbon atoms.

3. The method of claim 1, wherein the alcohol is methanol.

4. The method of claim 1, wherein the cyclopentadienyl rings of the ferrocenium salt are unsubstituted and the anion of the ferrocenium salt is selected from tetrafluoroborate, hexafluorophosphate, hexafluoroarsenate, hydroxypentafluoroantimonate, hexafluoroantimonate, tetrakis(4-trifluoromethylphenyl)borate, tetrakis(3,5-bis-(trifluoromethyl)phenyl)borate, or trifluoromethanesulfonate.

5. The method of claim 1, wherein the catalyst composition comprises an iron species in a ferrous oxidation state and an iron species in a ferric oxidation state.

6. The method of claim 1, wherein said treating further comprises evaporating the alcohol from the catalyst composition.

7. The method of claim 1, wherein said treating further comprises washing the catalyst composition with a non-polar solvent.

8. The method of claim 1, wherein said treating further comprises evaporating the alcohol from the catalyst composition, washing the catalyst composition with a non-polar solvent, and evaporating the non-polar solvent.

9. The method of claim 1, wherein the cationically polymerizable monomer is an epoxy monomer.

10. The method of claim 1, wherein said curing comprises exposing the polymerizable composition to oxygen.

11. A method of preparing a polymer, said method comprising:
forming a polymerizable composition comprising a monomer having at least one cationically polymerizable group, methanol, and a ferrocenium salt of formula
(Cp)₂FeX I
wherein
Cp is a cyclopentadienyl group that is unsubstituted or substituted with up to three substituents; and
X is an anion that is a tris-(fluorinated alkylsulfonyl)methide, bis-(fluorinated alkylsulfonyl)imide, tris-(fluorinated arylsulfonyl)methide, tetrakis-(fluorinated aryl)borate, alkyl sulfonate, fluorinated alkyl sulfonate, aryl sulfonate, fluorinated aryl sulfonate, or halogen-containing complex of a metal or metalloid;
the polymerizable composition has a molar ratio of cationically polymerizable groups to methanol that is at least 12:1;
thermally curing the polymerizable composition, said thermally curing comprising exposing the polymerizable composition to a gas comprising oxygen.

12. The method of claim 11, wherein the polymerizable composition has a molar ratio of cationically polymerizable groups to methanol that is at least 20:1.

13. The method of claim 11, wherein the cyclopentadienyl rings of the ferrocenium salt are unsubstituted and the anion of the ferrocenium salt is selected from tetrafluoroborate, hexafluorophosphate, hexafluoroarsenate, hydroxypentafluoroantimonate, hexafluoroantimonate, tetrakis(4-trifluoromethylphenyl)borate, tetrakis(3,5-bis-(trifluoromethyl)phenyl)borate, or trifluoromethanesulfonate.

14. The method of claim 11, wherein the cationically polymerizable monomer is an epoxy monomer.

15. A polymerizable composition comprising:
a monomer having at least one cationically polymerizable group;
methanol, wherein the polymerizable composition has a molar ratio of cationically polymerizable group to methanol that is at least 12:1; and
a ferrocenium salt of formula
(Cp)₂FeX I
wherein
Cp is a cyclopentadienyl group that is unsubstituted or substituted with up to three substituents; and
X is an anion that is a tris-(fluorinated alkylsulfonyl)methide, bis-(fluorinated alkylsulfonyl)imide, tris-(fluorinated arylsulfonyl)methide, tetrakis-(fluorinated aryl)borate, alkyl sulfonate, fluorinated alkyl sulfonate, aryl sulfonate, fluorinated aryl sulfonate, or halogen-containing complex of a metal or metalloid.

16. The polymerizable composition of claim 15, wherein the molar ratio of cationically polymerizable group to methanol is at least 20:1.

17. The polymerizable composition of claim 15, wherein the cationically polymerizable monomer is an epoxy monomer.

18. The polymerizable composition of claim 15, wherein the cyclopentadienyl rings of the ferrocenium salt are unsubstituted and the anion of the ferrocenium salt is selected from tetrafluoroborate, hexafluorophosphate, hexafluoroarsenate, hydroxypentafluoroantimonate, hexafluoroantimonate, tetrakis(4-trifluoromethylphenyl)borate, tetrakis(3,5-bis-(trifluoromethyl)phenyl)borate, or trifluoromethanesulfonate.

19. The polymerizable composition of claim 15, further comprising a gas comprising oxygen

20. The polymerizable composition of claim 19, wherein the polymerizable composition comprises an iron species in a ferrous oxidation state and an iron species in a ferric oxidation state.
